(19) United States
(12) Patent Application Publication
(10) Pub. No.: US 2011/0140682 A1
(43) Pub. Date: Jun. 16, 2011

(54) VOLTAGE REGULATOR SUITABLE FOR CMOS CIRCUIT

(75) Inventors: Shinichi IIZUKA, Suwon (KR); Youn Suk KIM, Yongin (KR); Joong Jin NAM, Seoul (KR); Jun Kyung NA, Anyang (KR); Sang Hoon HA, Suwon (KR)

(73) Assignee: SAMSUNG ELECTRO-MECHANICS CO., LTD., Suwon (KR)

(21) Appl. No.: 12/825,485

(22) Filed: Jun. 29, 2010

(30) Foreign Application Priority Data
Dec. 16, 2009 (KR) 10-2009-0125654

(51) Int. Cl. G05F 3/02

(52) U.S. Cl. 323/311

(57) ABSTRACT

There is provided a voltage regulator suitable for a CMOS circuit. A voltage regulator suitable for a CMOS circuit according to an aspect of the invention may include: a voltage setting unit setting a voltage across both terminals of a load; a voltage amplification unit setting an input voltage; and a voltage control unit controlling a voltage to be applied to the second connection node according to an output voltage of the voltage amplification unit, wherein the voltage across both terminals of the load is maintained to be constant regardless of variations in a power voltage.

### CROSS-REFERENCE TO RELATED APPLICATIONS

This application claims the priority of Korean Patent Application No. 10-2009-0125654 filed on Dec. 16, 2009, in the Korean Intellectual Property Office, the disclosure of which is incorporated herein by reference.

### BACKGROUND OF THE INVENTION

1. Field of the Invention

The present invention relates to a voltage regulator that can be applied to a complementary metal-oxide-semiconductor (CMOS) power amplifier, and more particularly, to a voltage regulator suitable for a CMOS circuit that is configured to provide a regulated voltage by using an n-type metal-oxide-semiconductor (NMOS) transistor to thereby reduce the size thereof and provide stable voltage and current.

2. Description of the Related Art

With advancements in mobile communications technologies, the demand for power amplifiers, which are used to amplify the output of RF signals in RF terminals of mobile communications terminals, has exploded in recent years. In particular, research has been actively conducted into power amplifiers using CMOS technology for integration and reduction in size, weight, and thickness.

Furthermore, low-dropout (LDO) voltage regulators of power amplifiers have been developed to stably control the operation of the power amplifiers. Also, development and research efforts focused on providing more stable voltage by using these LDO voltage regulators, have been made.

In the related art, an LDO voltage regulator includes a plurality of power PMOS transistors connected in parallel with each other in order to provide voltage required by a power amplifier.

By using this voltage regulator, a voltage having a constant level needs to be provided to the power amplifier despite variations in battery voltage.

FIG. 1 is a circuit block diagram illustrating a voltage regulator according to the related art.

Referring to FIG. 1, a voltage regulator 10 according to the related art may include an operational amplifier A1 and a PMOS transistor circuit PM1. The operational amplifier A1 is required to provide a voltage Vreg having a constant level to a power amplification unit 20, and amplifies an input voltage Vin according to a ratio between resistors R1 and R2 to provide the amplified input voltage to a power terminal TP of the power amplification unit 20. The PMOS transistor circuit PM1 has a plurality of PMOS transistors, each of which has a gate connected to an output terminal of the operational amplifier A1, a source connected to a battery voltage Vbat terminal, and a drain connected to a voltage terminal TnP of the power amplification unit 20.

Since this voltage regulator 10 amplifies the input voltage Vin to provide the amplified input voltage Vin to the power terminal TP of the power amplification unit 20, a voltage to be provided to the power amplification unit 20 can be controlled by the input voltage Vin.

Therefore, despite variations in the battery voltage, by maintaining the input voltage at a constant level, it is possible to provide a voltage having a constant level to the power amplification unit 20.

However, the voltage regulator 10 may be manufactured using a CMOS IC together with the power amplification unit 20. Here, the PMOS transistor circuit PM1, included in the voltage regulator 10, may have thousands of PMOS transistors. Here, the size of these PMOS transistors is bulky, making it difficult to manufacture compact ICs.

### SUMMARY OF THE INVENTION

An aspect of the present invention provides a voltage regulator suitable for a CMOS circuit that is configured to provide a regulated voltage by using an NMOS transistor to thereby reduce the size thereof and provide stable voltage and current.

According to an aspect of the present invention, there is provided a voltage regulator suitable for a CMOS circuit, the voltage regulator including: a voltage setting unit setting a voltage across both terminals of a load so that a first voltage, obtained by dividing a voltage to be applied to a first connection node between a power voltage terminal and the load according to a predetermined ratio, is equal to a second voltage, obtained by dividing a differential voltage between a predetermined third connection node and a second connection node of the load, located opposite to the first connection node of the load, at a predetermined ratio; a voltage amplification unit setting an input voltage to be equal to a voltage at the third connection node and amplifying the input voltage; and a voltage control unit provided between the second connection node and a ground and controlling a voltage to be applied to the second connection node according to an output voltage of the voltage amplification unit, wherein the voltage across both terminals of the load is maintained to be constant regardless of variations in a power voltage.

The voltage setting unit may include: first and second resistors connected in series between the first connection node and the ground; third and fourth resistors connected in series between the second connection node and the third connection node; and a first operational amplifier having an inverting input terminal connected to a connection node between the first and second resistors, a non-inverting input terminal connected to a connection node between the third and fourth resistors, and an output terminal connected to the third connection node.

The voltage amplification unit may include a second operational amplifier having a non-inverting input terminal connected to a terminal of the input voltage, an inverting input terminal connected to the third connection node, and an output terminal connected to the voltage control unit.

The voltage control unit may include an NMOS transistor having a drain connected to the second connection node, a gate connected to the output terminal of the second operational amplifier, and a source connected to a ground.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a circuit block diagram illustrating a voltage regulator according to the related art; and

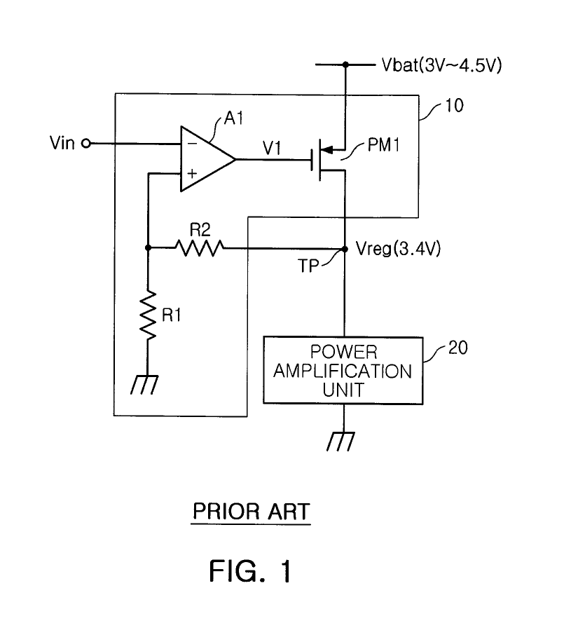

FIG. 2 is a circuit block diagram illustrating a voltage regulator according to an exemplary embodiment of the present invention.

### DETAILED DESCRIPTION OF THE PREFERRED EMBODIMENT

Exemplary embodiments of the present invention will now be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the same reference numerals will be used throughout to designate the components having substantially the same configuration and function.

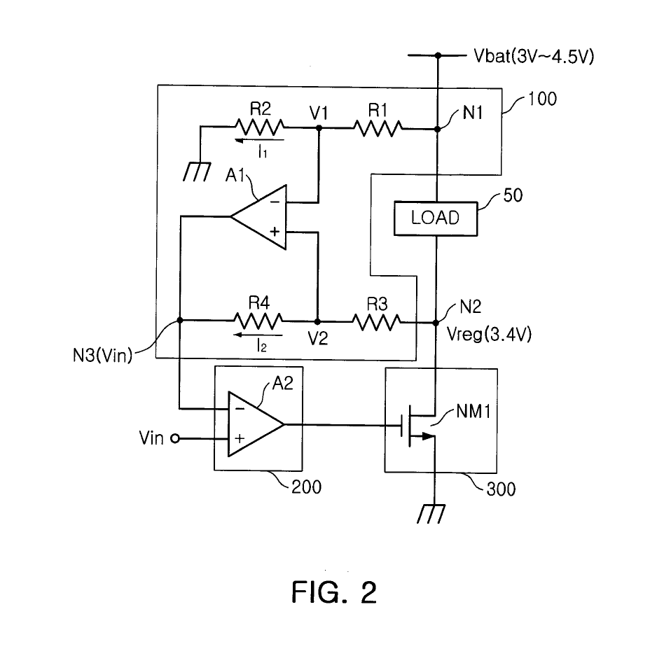

FIG. 2 is a circuit block diagram illustrating a voltage regulator according to an exemplary embodiment of the invention.

Referring to FIG. 2, a voltage regulator according to this embodiment includes a voltage setting unit 100. The voltage setting unit 100 determines a voltage across both terminals of the load 50 such that a first voltage V1, obtained by dividing a voltage being applied to a first connection node N1 between a power voltage Vbat terminal and the load 50 at a predetermined ratio, is equal to a second voltage V2, obtained by dividing a differential voltage between a predetermined third connection node N3 and a second connection node N2 of the load 50, which is located opposite to the first connection node N1 of the load 50, at a predetermined ratio.

Here, the load 50 is an analog circuit which is composed of a CMOS circuit. The load 50 may be a power amplifier.

Furthermore, the voltage regulator according to this embodiment includes a voltage amplification unit 200 and a voltage control unit 300. The voltage amplification unit 200 sets the input voltage Vin to be equal to a voltage at the third connection node N3, and amplifies the input voltage Vin. The voltage control unit 300 is formed between the second connection node N2 and a ground and controls a voltage to be applied to the second connection node N2 according to an output voltage of the voltage amplification unit 200.

Here, the voltage across both terminals of the load 50 is maintained to be constant regardless of variations in the power voltage Vbat.

The voltage setting unit 100 may include first and second resistors R1 and R2 connected in series between the first connection node N1 and the ground, third and fourth resistors R3 and R4 connected in series between the second connection node N2 and the third connection node N3, and a first operational amplifier A1 having an inverting input terminal connected to a connection node between the first and second resistors R1 and R2, a non-inverting input terminal connected to a connection node between the third and fourth resistors R3 and R4, and an output terminal connected to the third connection node N3.

The voltage amplification unit 200 may include a second operational amplifier A2 having a non-inverting input terminal connected to an input voltage Vin terminal, an inverting input terminal connected to the third connection node N3, and an output terminal connected to the voltage control unit 300.

The voltage control unit 300 may include an NMOS transistor NM1 that has a drain connected to the second connection node N2, a gate connected to the output terminal of the second operational amplifier A2, and a source connected to the ground.

Hereinafter, the operation and effects of the invention will be described in detail with reference to the accompanying drawings.

The voltage regulator according to this embodiment will be described with reference to FIG. 2. As described above, the voltage setting unit 100 according to this embodiment determines a voltage Vbat-Vreg across both terminals of the load 50 so that the first voltage V1, obtained by dividing the power voltage Vbat to be applied to the first connection node N1 according to a predetermined ratio, is equal to the second voltage V2b, obtained by dividing a differential voltage Vreg-Vin between the second connection node N2 of the load 50 and the predetermined third connection node N3 according to a predetermined ratio.

Here, the voltage at the third connection node N3 becomes the same as the input voltage Vin by the voltage amplification unit 200 according to this embodiment.

Here, the voltage control unit 300 according to this embodiment is formed between the second connection node N2 and the ground, and controls the voltage to be applied to the second connection node N2 according to the output voltage of the voltage amplification unit 200.

By the voltage setting unit 100, the voltage amplification unit 200, and the voltage control unit 300 according to this embodiment, the voltage across both ends of the load 50 is maintained to be constant regardless of variations in the power voltage Vbat.

Hereinafter, the operations of the voltage setting unit 100, the voltage amplification unit 200, and the voltage control unit 300 will be described in detail with reference to detailed circuit diagrams.

First, in the voltage setting unit 100 according to this embodiment, when a current I1 flows through the second resistor R2 and a current I2 flows through the fourth resistor R4, the first voltage V1 and the second voltage V2 may be obtained by the following Equations 1 and 2.

I1=V1/R2=Vbat/(R1+R2)∴V1=[R2/(R1+R2)]Vbat [Equation 1]

I2=(V2−Vin)/R4=(Vreg−Vin)/(R3+R4)∴V2=(R4Vreg+R3Vin)/(R3+R4) [Equation 2]

In consideration of the characteristics of the first operational amplifier A1 of the voltage setting unit 100, since the first voltage V1 at the inverting input terminal of the first operational amplifier A1 is equal to the second voltage V2 at the non-inverting input terminal of the first operational amplifier A1, the voltage Vreg at the second connection node N2 may satisfy the following Equation 3.

[R2/(R1+R2)]Vbat=(R4Vreg+R3Vin)/(R3+R4) [Equation 3]

The above Equation 3 is equivalent to the following Equation 4 in terms of the voltage Vreg at the second connection node N2.

Vreg=[R2(R3+R4)][R4(R1+R2)]Vbat−[R3/R4]Vin [Equation 4]

In the above Equation 4, when the first, second, third, and fourth resistors R1, R2, R3, and R4 have the same value, the above Equation 4 may be rewritten as the following Equation 5.

Vreg=Vbat−Vin [Equation 5]

Referring to the above Equation 5, when the input voltage Vin is maintained to be constant, a change in the power voltage Vbat involves a change in the voltage Vreg at the second connection node N2. As a result, the voltage Vbat-Vreg to be applied to both ends of the load 50 is not changed and is maintained to be constant.

As described above, in the exemplary embodiment of the invention, the voltage regulator is realized using the NMOS transistor, thereby maintaining the voltage across both ends of the load constant despite variations in the voltage of the battery and causing a significant increase in the size.

As set forth above, according to exemplary embodiments of the invention, a regulated voltage can be supplied using an NMOS transistor, thereby reducing size and providing voltage and current.

While the present invention has been shown and described in connection with the exemplary embodiments, it will be apparent to those skilled in the art that modifications and variations can be made without departing from the spirit and scope of the invention as defined by the appended claims.

What is claimed is:

1. A voltage regulator suitable for a CMOS circuit, the voltage regulator comprising:
a voltage setting unit setting a voltage across both terminals of a load so that a first voltage, obtained by dividing a voltage to be applied to a first connection node between a power voltage terminal and the load according to a predetermined ratio, is equal to a second voltage, obtained by dividing a differential voltage between a predetermined third connection node and a second connection node of the load, located opposite to the first connection node of the load, at a predetermined ratio;
a voltage amplification unit setting an input voltage to be equal to a voltage at the third connection node and amplifying the input voltage; and
a voltage control unit provided between the second connection node and a ground and controlling a voltage to be applied to the second connection node according to an output voltage of the voltage amplification unit,
wherein the voltage across both terminals of the load is maintained to be constant regardless of variations in a power voltage.

2. The voltage regulator of claim 1, wherein the voltage setting unit comprises:
first and second resistors connected in series between the first connection node and the ground;
third and fourth resistors connected in series between the second connection node and the third connection node; and
a first operational amplifier having an inverting input terminal connected to a connection node between the first and second resistors, a non-inverting input terminal connected to a connection node between the third and fourth resistors, and an output terminal connected to the third connection node.

3. The voltage regulator of claim 2, wherein the voltage amplification unit comprises a second operational amplifier having a non-inverting input terminal connected to a terminal of the input voltage, an inverting input terminal connected to the third connection node, and an output terminal connected to the voltage control unit.

4. The voltage regulator of claim 3, wherein the voltage control unit comprises an NMOS transistor having a drain connected to the second connection node, a gate connected to the output terminal of the second operational amplifier, and a source connected to a ground.
